(19) United States
(12) Patent Application Publication
(10) Pub. No.: US 2008/0262637 A1
(43) Pub. Date: Oct. 23, 2008

(54) Control for a motorized blind

(75) Inventor: David M. Dorrough, Eagle, ID (US)

Correspondence Address: David Dorrough, 3044 W. Sugarberry Drive, Eagle, OR, 83616, US

(73) Assignee: David M. Dorrough, Eagle, ID (US)

(21) Appl. No.: 11/788,242

(22) Filed: Apr. 20, 2007

(51) Int. Cl. G05B 15/00

(52) U.S. Cl. 700/1

(57) ABSTRACT

A control method for a motorized blind. The control method employs an input device that sends signals to a logic control unit. The logic control unit processes the inputs received from the input device, then controls a plurality of motors to properly control of the angle and position of the slats of a motorized blind.

### CROSS REFERENCE TO RELATED APPLICATIONS

Not Applicable

### STATEMENT REGARDING FEDERALLY SPONSORED RESEARCH AND DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

There are a variety of means that have been employed to motorize the functions of tilting the slats of a blind to the right angle, and lifting (moving) the slats of a blind to the right position. Some of them limit motorization to only motorizing the tilt function. Others limit motorization to only motorizing the lift function. Motorized blinds have been devised that utilize a motor to control both the lift and tilt operations. These blinds connect the both lift cords and tilt cords to the same reel. In the operation of these systems, both the lifting (moving) and tilting functions occur simultaneously. Other complex mechanisms have been devised to control the lift and tilt operations in a blind. A good system that provides for independent control of the lift and tilt functions is needed.

### BRIEF SUMMARY OF THE INVENTION

The control method employs an input device that sends signals to a logic control unit. The logic control unit processes the inputs received from the input device, then controls a plurality of motors to properly control of the angle and position of the slats of a motorized blind.

### BRIEF DESCRIPTION OF THE SEVERAL VIEWS OF THE DRAWINGS

This invention is described by the appended claims. The preferred embodiment is described and makes reference to the following figures which are explained briefly as follows.

FIG. 1 is an illustration of one embodiment of the present invention in the form of a venetian blind. It is shows a blind assembly with the blind slats 2 in the lowered position and with the blind slats 2 tilted open.

FIG. 2 is an overhead view of the headrail 1. Within the head rail two tubes 28, 29 are illustrated. In the embodiment of this illustration, one tube 28 serves the function of driving the lift cords 32, 33 and the second tube 29 is responsible for the tilt function.

FIG. 3 is an overhead view of a headrail 1. In this illustration a 90-degree section of each of the tubes 28, 29 has been cut-away to reveal the parts within the tubes 28, 29.

FIG. 4 is shows an end view perspective of the blind for this embodiment. From the perspective shown in this figure, the extrusion profile of the headrail 1 can be seen. Two motor mounts 24, 25 can also be seen that that are mounted within the channels 7, 8 of the headrail 1.

FIG. 5 is a state diagram for a possible control logic unit.

FIG. 6 is a circuit diagram that could be used to perform the control logic function for the described embodiment.

FIG. 7 is an overhead section view of the lift tube 28, and the tilt tube, 29 and cords 32, 33, 41, 42, 43, 44 that are routed in a configuration that represents one possible configuration. In this particular configuration, one of the tilt cords 41, 43 is routed around a diverting object 60 to create an unobstructed path for the cord 41, 43.

FIG. 8 is an alternate perspective of the configuration illustrated in FIG. 7. It is a section view as seen from section line 8-8 of FIG. 7.

FIG. 9 is an overhead section view of the lift tube 28, and the tilt tube 29, and cords 32, 33, 41, 42, 43, 44, 90 that are routed in one possible configuration. In this particular configuration, one of the lift cords 90 is routed around a diverting object 66 to create an unobstructed path for the cord 90.

FIG. 10 is an alternate perspective of the configuration illustrated in FIG. 9. It is a section view as seen from section line 10-10 of FIG. 9.

FIG. 11 is an overhead section view of the lift tube 28, and the tilt tube 29, and cords 32, 33, 41, 42, 43, 44 that are routed in a one possible configuration. In this particular configuration, one of the tilt cords 41, 43 is routed at an angle to create an unobstructed path for the cord 41, 43.

FIG. 12 is an alternate perspective of the configuration illustrated in FIG. 1. It is a section view as seen from section line 12-12 of FIG. 11

FIG. 13 is an overhead section view of the lift tube 28, and the tilt tube 29, and cords 32, 33, 41, 42, 43, 44 that are routed in a configuration that represents another configuration. In this particular configuration, the lift cord 32, 33 enters the headrail 1 at a position along the length of the headrail 1 that is different than the tilt cords 41, 42, 43, 44 to an unobstructed path for all of the cords 32, 33, 41, 42, 43, 44.

FIG. 14 is an alternate perspective of the configuration illustrated in FIG. 13. It is a section view as seen from section line 14-14 of FIG. 13.

FIG. 15 is an overhead section view of the lift tube 28, and the tilt tube 29, and cords 32, 33, 41, 42, 43, 44, 90 that are routed in a configuration that represents another possible configuration. This particular configuration employs two lift cords 32, 33, 90. In this configuration, the one of the lift cord 90 enters the headrail I at a position along the length of the headrail 1 that is different than the point where the other lift cord 32, 33 and tilt cords 32, 33, 41, 42, 43, 44 enter. The result is another unobstructed path for all of the cords 32, 33, 41, 42, 43, 44,90.

FIG. 16 is an alternate perspective of the configuration illustrated in FIG. 15. It is a section view as seen from section line 16-16 of FIG. 15.

FIG. 17 is a section view that shows the tilt tube 29 on the left and the lift tube 28 on the right. In this illustration one of the lift cords 32, 33, 90 is routed around each side of the tilt tube 29 to create an unobstructed path for the cords 32, 33, 41, 42, 43, 44, 90.

### DETAILED DESCRIPTION OF THE PREFERRED EMBODIMENT

The preferred embodiment describes a venetian blind application. However, it is applicable to any type of blind that employs a plurality of parallel slats 2 including venetian blinds, vertical blinds, cloth blinds such as those that suspend fabric slats between two sheer fabric facings, and other types of blinds with slats. A group of slats 2 is a group a group of parallel members that allows light to pass when the slats are angled in one particular direction, but which substantially blocks light when the angle has changed. These parallel members may be called slats, vanes, ribbons, strips, planks, blades, or other names. However, here they are referred to simply as slats 2. Throughout the description, the function of changing the physical location, or position, of the slats is referred to as lift, or lifting. The function of changing the angle of the slats 2 is referred to as tilt, or tilting.

Many different embodiments are possible. The preferred embodiment describes one particular venetian blind, however, practical application other embodiments of venetian blinds, and to other types of blinds, can be carried out by those skilled in the art.

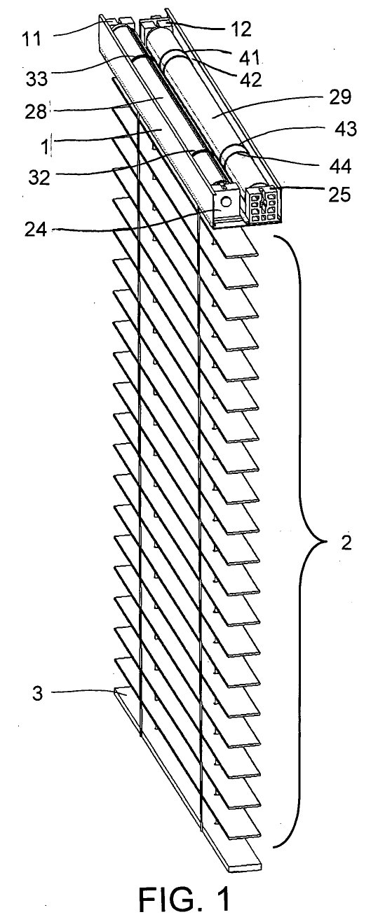

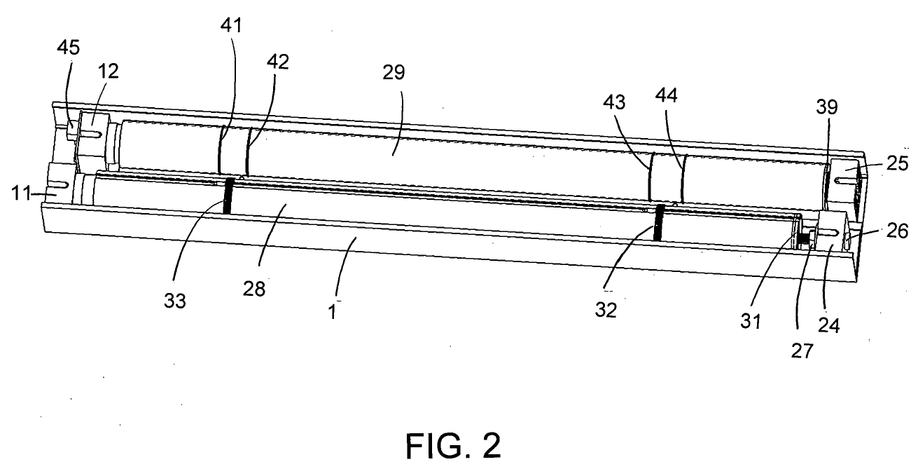

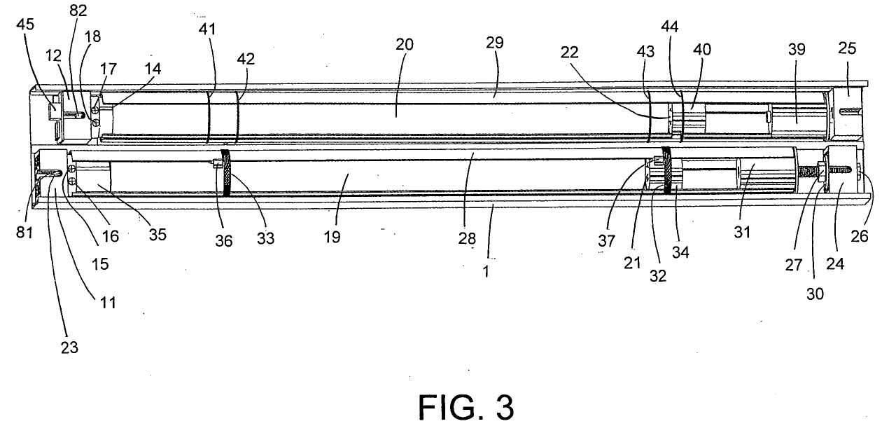

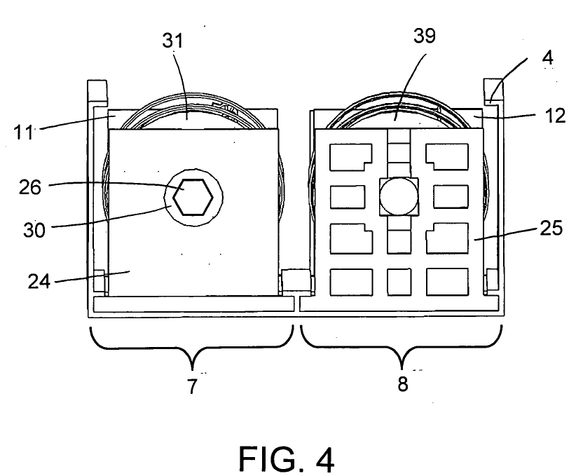

The preferred embodiment utilizes a pair of motors 19, 20. The first motor 19 serves the purpose of driving the lift function of the blind, and the second motor 20 serves to drive the tilt function of the blind. Both motors 19, 20 are contained within the same headrail 1. The type of motor selected for the preferred embodiment is commonly referred to as a tubular motor. The tubular motors used in this embodiment are bi-directional motors that include a self-contained gearbox, brake, and limit switches. Each of the motors 19, 20 is mounted rigidly to the headrail 1. A tube 28, 29 is placed around the motors 19, 20 and an adapter 34, 40 connects the drive shaft of the motor to the tube so that the power of the motor causes the tube to rotate around the motor. In this embodiment the tube becomes a reel for the cords. FIG. 1 depicts the preferred embodiment of a venetian blind. It shows the headrail 1, lift cords 32, 33, tilt cords 41, 42, 43, 44, slats 2, and bottomrail 3. FIG. 2 shows a close-up view of the headrail 1 and the components installed in the headrail 1. FIG. 3 is a closer up view the same headrail 1 with a section of the tubes 28, 29, cut-away to reveal the components inside. The headrail 1 itself in the preferred embodiment is made from extruded aluminum. Along both top edges of the headrail is a lip 4. This lip 4 serves to reinforce and add strength. The headrail 1 also has two channels 7, 8 along the bottom that are an integrated part of the extrusion profile. These channels 7, 8 serve the function of holding the motor mounts 11, 12, 24, 25 in the correct position. The motor mounts 11, 12, 24, 25 are also screwed into place to prevent them from sliding within the channel 7, 8. In this embodiment four motor mounts 11, 12, 24, 25 are used: one for the lift tube 24, one for the lift motor 11, one for the tilt tube 25, and one for the tilt motor 12. The mounts for the lift motor 19 and lift tube 28 are placed in the first channel 7 and the motor mounts for the tilt motor 20 and tilt tube 29 are placed in the second channel 8. Screws are used to hold all four motor mounts 11, 12, 24, 25 in place. The screws are inserted through the bottom side of the headrail 1 up into the motor mount 11, 12, 24, 25. Other methods of mounting the motors 19, 20 are possible.

The motors used in this embodiment of the invention are tubular motors. These motors commonly used today in awnings, projection screens, and blinds. These tubular motors have several integrated features: they are bidirectional, they have integrated gearboxes, they have integrated limit switches, and they have an integrated electromagnetic brake. Components on these motors include a mounting shaft 81, 82, a limit switch driver 14, 35, limit switch set screws 15, 16, 17, 18, a motor body 19, 20, and a drive shaft 21, 22. The tubular motors 19, 20 typically have a four-sided, square, mounting shaft 81, 82. In this embodiment this mounting shaft 81, 82 is inserted into a complementary hole in the motor mount 11, 12. Then a pin 23 is placed through the hole in the mounting shaft 81, 82 to keep the mounting shaft 81, 82 from sliding out of the motor mount 11, 12.

The first motor mount 11 for the lift motor 19 is connected in this manner. The motor mount 24 for the second end of the lift motor 19 is also inserted in the first channel 7 in the headrail 1 and is attached with screws. However, in this embodiment the motor mount 24 doesn't attach directly to the motor 19. Instead, the motor mount 24 for the lift tube 28 has a round hole in it. A bolt 26 is placed through the hole in the motor mount. A nut 27 is used to secure the bolt 26 in place. Washers 30 are used, one on each side of the motor mount 24. Onto the bolt 26, a threaded tube adapter 31 is installed. The threaded tube adapter 31 has internal threads that match the threads of the bolt 26. The threaded tube adapter 31 is effectively screwed onto the bolt 26. The threaded tube adapter 31 is inserted into the first end of the lift tube 28. Screws are used to secure the lift tube 28 to the threaded tube adapter 31. The purpose of the bolt 26 and threaded tube adapter 31 is to cause the tube to travel axially as tube spins. This axially movement allows the lift cords 32 33 to wind evenly, without overlap, as the tube 28 spins. The result is that the bottomrail 3 remains level as it rises. Other methods to wind the cords evenly are possible.

To link the power of the motor 19 to the tube 28 a drive adapter 34 is used. The drive adapter 34 couples the drive shaft 21 of the motor to the tube 28. The drive shafts 21 22 of tubular motors 19 20 typically have two flat sides that are parallel to each other and two rounded sides that are opposite each other. The drive adapter 34 fits onto the output shaft 21 and is normally held in place with a clip that fits into a groove 69 in the end of the drive shaft 21. The drive adapter 34 has physical contours on its exterior surface that fit complementary physical contours on the interior of the tube 28. This arrangement connects the motor 19 to the tube 28. No screws are used to connect the drive adapter 34 to the lift tube 28. The tube 28 is allowed to slide axially over the drive adapter 34 as the drive shaft 21 spins.

The second end of the tube 28 attaches to the limit switch receiver 35 on the motor 19. The limit switch receiver 35 on the motor 19 is driven by the tube 28. The limit switch receiver 35 also serves the function of supporting the end of the lift tube 28. The lift tube 28 is allowed to slide axially over the limit switch receiver 35, consequently the limit switch receiver 35 is long enough to support the lift tube 28 throughout the total distance that the lift tube 28 may travel. To make this possible the limit switch receiver 35 is connected to the limit switches that are integrated into the motor 19.

There are two limit-switch set screws on the motor 15, 16. The first set screw 15 determines that maximum clockwise position of the motor and the second set screw 16 determines the maximum counterclockwise position of the motor. The rotational limits of the motor 19 can be set by turning the screws 15, 16 to the appropriate position. When the motor 19 reaches the predetermined position, as determined by the set screws 15, 16, the motor 19 stops. The 32, 33 lift cords need to be joined to the tube 28. Many different means of accomplishing this are possible. In this embodiment, the tube is provided with a groove 69 that has a dimension that precisely matches the dimension of the cord mount 36, 37. The cord mount 36, 37 fits within the groove 69 in the tube 28. It is designed to be a precise enough fit so that pressure holds the cord mount 36, 37 in place within the groove 69. However, adhesive can be used to secure cord mounts 36, 37 that may be out of tolerance. The lift cords 32, 33 fit under the cord mount 36 37. To keep the lift cords 32, 33 from sliding out, a small grommet 38 39 is crimped onto the end of the cord 32, 33.

In this embodiment, two motor mounts are used to support the tilt motor 12 and tilt tube 25. Both mounts 12 25 fit within the second channel 8 in the headrail 1. Both motor mounts 12 25 are held into place with screws. The screws go through holes in the bottom of the headrail 1 and extend up into the motor mounts. The first motor mount 12 has a square hole in it that is coupled directly to the mounting shaft 82 of the first motor 20. The second motor mount 25 doesn't mount directly to the motor 20, but rather connects to an idler 39. The idler 39 fits within the end of the tilt tube 29. The idler 39 serves the purpose of holding the end of the tube 29 in a fixed position, while allowing it to simultaneously rotate freely. The idler 39 may have ball bearings to allow it to rotate freely.

To couple the power of the tilt motor 20 to the tube 29 a drive adapter 40 can be used. The drive adapter 40 connects the drive shaft 22 of the tilt motor 20 to the tube 29. The drive adapter 40 fits onto the drive shaft 22 and is normally held in place with a clip that fits into a groove 65 in the end of the drive shaft 22. The drive adapter in this embodiment 40 has physical contours on its exterior surface that match up with complementary features on the interior of the tilt tube 29 so that the motion of the drive shaft 22 causes the drive adapter 40 to spin. The motion of the drive adapter 40 causes the tube 29 to spin.

Two different types of lift cord configurations are commonly used today in venetian blinds. The first method uses a single lift cord at each lift point. The second method utilizes two lift cords 32, 33, 90 at each lift point. In both methods, the lift cords 32, 33, 90 run vertically from the headrail down to the bottom of the blind. They attach to the bottomrail 3 and perform the function of lifting the bottomrail 3. Many venetian blinds have just two lift points, one near each end of the blind. However, wider blinds may have additional lift points interposed between the lift points near either end of the blind. With the single-lift-cord method holes are commonly placed through each slat 2 and the lift cord 32, 33, 90 is routed through the holes. The dual-lift-cord method doesn't normally utilize slats 2 with holes them holes in them. Instead the lift cords 32, 33, 90 are routed with one lift cord 32, 33 90 on each side of the slats 2. Embodiments of these common lift cord configurations are described in the section below. Other configurations of lift cords 32, 33, 90 are possible.

In an embodiment of the single-lift cord configuration, one end of the lift cord 32, 33, 90 is attached to the bottomrail 3. The lift cord 32, 33, 90 is then routed up through a hole in each of the blind slats 2. After being routed through a hole in each of the blind slats 2 it is routed through a hole 50 in the bottom of the headrail 1. It is then routed to the lift tube 28. After reaching the lift tube 28, the lift cord 32, 33, 90 is then routed under a cord mount 36. A small metal cylinder 38 is crimped onto the end of the cord 32, 33, 90 to prevent the lift cord 32, 33, 90 from slipping out. Each of the lift cords 32, 33, 90 is routed in the manner just described. Each of the lift cords 32, 33, 90 are the same length so that the bottomrail 3 is horizontal and that the slats 2 remain horizontal as they rise.

An embodiment of the dual-lift cord configuration uses two lift cords 32, 33, 90 at each lift point. For example, a blind with three lift points, will consequently use six lift cords 32, 33, 90. In the dual-lift cord configuration, a first lift cord 32, 33, 90 is attached to the front face of the bottomrail 3, and a second lift cord 32 33 is attach the opposite face of the bottomrail 3. Both of the lift cords 32, 33, 90 are normally be attached a point on the bottomrail 3 directly opposite each other. The lift cords 32, 33, 90 are then routed upward, with one cord on each side of the blind slats 2. After being routed past all of the blind slats 2, the lift cords 32, 33, 90 are then routed through a hole in the bottom of the headrail 1. They are then routed to the lift tube 28. To attach to the lift cords 32, 33, 90 to the lift tube 28 in this embodiment, the lift cords 32 33 are routed under a cord mount 36. Then a small metal cylinder 38 is crimped onto the end of the lift cord 32, 33, 90 to prevent it from slipping out.

Tilt cords 41, 42, 43, 44 can be secured to the tubes 29 using the same method that is used for the lift cords 32, 33, 90. Tilt cords 41, 42, 43, 44 can be joined to the tilt tube 29 using a cord mount 63, 64. In this embodiment the tube 29 is provided with a groove 65 that has a dimension that closely matches the dimension of the cord mount 63, 64. In this embodiment the cord mount 63, 64 fits within the groove 65 in the tube 29. A precise fit between the groove 65 and the cord mount 63, 64 can hold the cord mount 63, 64 in position. Alternatively, adhesive can be used to secure the cord mounts 63 64. Then to keep the tilt cords 41, 42, 43, 44 from sliding out, a small metal cylinder 61, 62 is crimped onto the end of the cord 41, 42, 43, 44. Many other means of attaching the tilt cords 41, 42, 43, 44.to the tilt tube 29 are possible.

Ladderbraid is a cord that is normally responsible for controlling the angle of the slats 2 in a venetian blind. Ladderbraid looks somewhat like a ladder. It consists of two main tilt cords 41, 42, 43, 44 and a plurality of cross-members that connect the two tilt cords 41, 42, 43, 44. Each slat 2 of the blind normally rests on a separate cross-member of the ladderbraid.

Ladderbraid is used in the preferred embodiment because the preferred embodiment describes a venetian blind, and ladderbraid is commonly used in venetian blinds. However, many other types of cord, or linkages can be employed to control the angle of the slats. For example in a vertical blind the slats are commonly hung from rotating piece. The angle of the rotating piece is commonly driven with cords or chain-type linkages. In cloth blinds such as those that suspend fabric slats between two sheer fabric facings, the sheer fabric facings perform the same function as the ladderbraid and tilt cords.

Tilt cords 41, 42, 43, 44 are discussed throughout the preferred embodiment. However, a tilt cord is any of many types of connecting devices. This could include, but is not limited to belts, chains, straps, tapes, webbing, direct linkages, rods, connector pieces, cloth sheets, etc. The tilt cords 41, 42, 43, 44 could be solid pieces, or flexible pieces, or a combination of the two. Many configurations are possible.

The angle of the slats 2 is controlled by lifting one of the tilt cords 41, 42, 43, 44 higher than the other tilt cord 41, 42, 43, 44. Venetian blinds typically have two or more ladderbraids. Many blinds have just two ladderbraids - one at each end of the blind. However, wider windows often have additional ladderbraids interposed between the ladderbraids at each end. Each of the ladderbraids normally runs vertically from the headrail 1 down to the bottomrail 3 of the blind. To describe the routing of the tilt cords of the ladderbraid, the description will begin at the bottom of the blind and work up to the top.

The end of the first tilt cord 41, 43 is attached to the front edge of the bottomrail 3. The second tilt cord 42, 44 is attached to the opposite side of the bottomrail 3. The ladderbraid extends vertically up from the bottomrail 3. A plurality of cross-members connects two tilt cords 41, 42 43, 44. One slat is placed upon each cross-member, up to the headrail 1. Next, the tilt cords 41, 42, 43, 44 are routed through holes 70, 71 in the bottom of the headrail 1. There is one hole for each of the ladderbraid's tilt cords 70, 71. The ladderbraid is then routed and mechanically connected to the tilt tube 29.

In this embodiment both tilt cords 41, 42, 43, 44 are attached to the tilt tube 29. They are routed so that each tilt cord 41, 42, 43, 44 makes initial contact with the tilt tube 29 on opposite sides of the tilt tube 29. They are also attached to the tilt tube 29. The spinning tilt tube 29 causes one of the tilt cords 41, 42, 43, 44 to wind around the tilt tube 29 while the other tilt cord 41, 42, 43, 44 simultaneously unwinds. The effect of driving the second motor 20 is to cause the slats 2 of the blind to tilt. It is also possible to connect only one of the tilt cords 41, 42, 43, 44 to the tilt tube 29 and still achieve the tilting operation. In the preferred embodiment, the tilt cords 41, 42, 43, 44 are attached to the tilt tube 29 using the same method that is used to attach the lift cords 32, 33, 90 to the lift tube 28.

Methods of routing the tilt cords 41, 42, 43, 44 and lift cords 32, 33, 90 are employed to ensure that the lift cords 32, 33, 90 and tilt cords 41, 42, 43, 44 don't interfere and tangle with each other. For aesthetic reasons it is common practice in venetian blinds to have the tilt cords 41, 42, 43, 44 and lift cords 32, 33, 90 rise vertically across the slats 2 at substantially the same position along the length of the slats 2. As a result, the tilt cords 41, 42, 43, 44 and lift cords 32, 33, 90 typically enter the headrail 1 at substantially the same position along the length of the headrail 1. So that there is an available path for all of the cords 32, 33, 90, 41, 42, 43, 44, a routing method is provided. There are four different routed methods described to provide a path for each of the tilt cords 41, 42, 43, 44 and lift cords 32, 33, 90. The first method is to divert some of the cords 32, 33, 90, 41, 42, 43, 44 out of the path of the other cords 32, 33, 90, 41, 42, 43, 44. The second method is to route cords 32, 33, 90, 41, 42, 43, 44 at an angle such that they don't contact the other cords 32, 33, 90, 41, 42, 43, 44. The third method involves offsetting the holes 50, 70, 71, 72 for the lift cords 32, 33, 90 and tilt cords 41, 42, 43, 44 so that they don't interfere with each other. The fourth method is to route each of the cords from one tube, around opposite sides of the opposite tube. More details on each of these four methods are described below. A few examples of these routing methods are illustrated in FIG. 7-17 that show a few of the many possible embodiments of these methods.

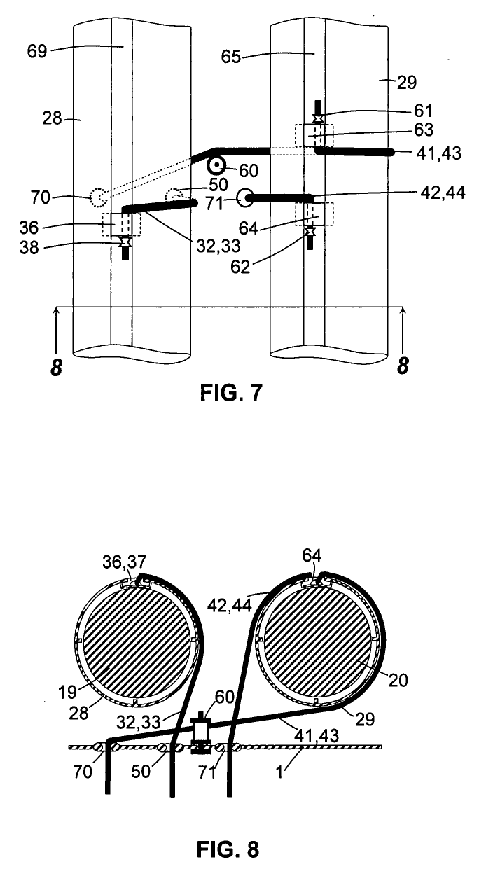

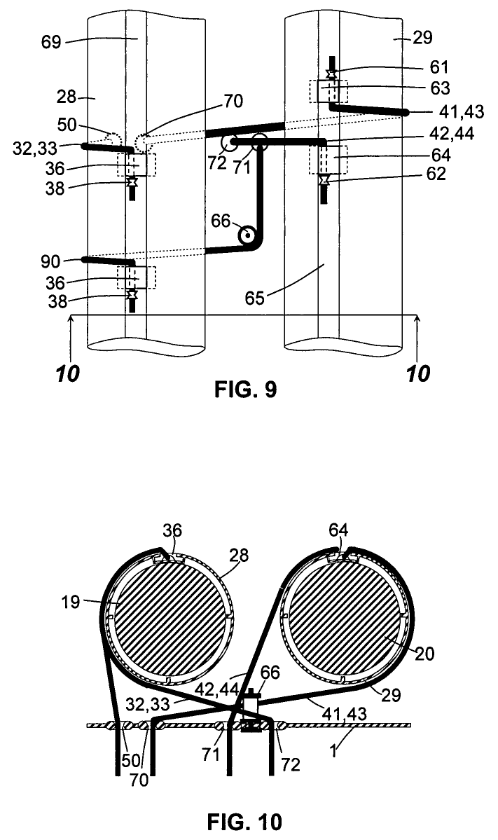

One method of creating a free, unobstructed routing path for the cords 32, 33, 90, 41, 42, 43, 44 is to divert some of the cords or all of the cords, 32, 33, 90, 41, 42, 43, 44 of the group the tilt cords 41, 42, 43, 44 and lift cords 32, 33, 90 into an unobstructed path by routing them out of the obstructed path by creating a path that routes one or a plurality of the cords 31, 32, 90, 41, 42, 43, 44 around a diverting object 60, 66, such as a pulley or a non-rotating object that the cords 32, 33, 90, 41, 42, 43, 44 can slide across. Many embodiments of this method are possible. However, two embodiments of this method are shown in FIG. 7, 8, 9, and 10. FIG. 7 and 8 are two illustrations of the same configuration from two different perspectives that illustrate a configuration that employs a single lift cord 32, 33 per lift point. In these FIG. 7 and 8 one of the tilt cords 41, 43 is routed out of the obstructed path and around a diverting object 60, creating a free path for all of the cords 32, 33, 42, 44. FIG. 9 and 10 are two illustrations of one configuration from two different perspectives that employ the dual-lift-cord-per-lift-point method. In this embodiment one of the lift cords 32, 33 is routed out of the obstructed path and around a diverting object 66.

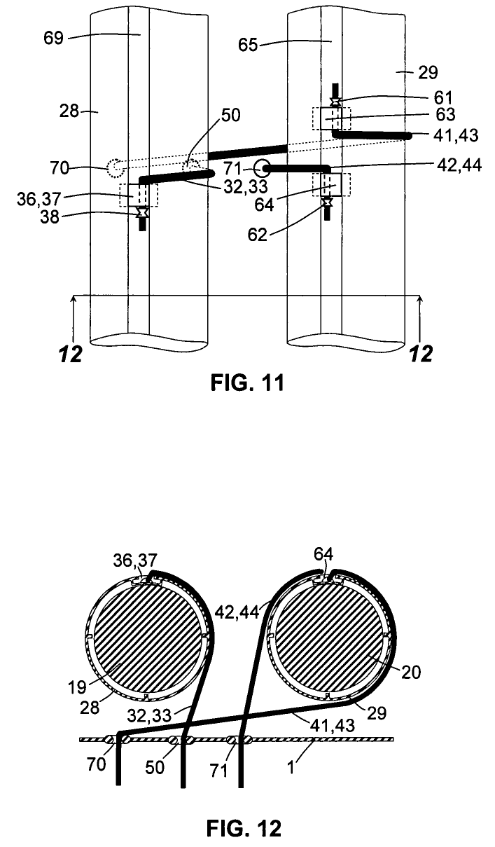

Routing the cords, 32, 33, 41, 42, 43, 44 of the group of tilt cords 41, 42, 43, 44, and lift cords 41, 42, 43, 44 at an angle that is not perpendicular to the length of the headrail 1 provides another method of creating an unobstructed path. There are many different possible embodiments of this method. One embodiment of this method is illustrated in FIG. 11 and 12. FIG. 11 and 12 are two illustrations of the same configuration from two different perspectives. In FIG. 1 and 12 one of the tilt cords 41, 43 is routed at an angle so that it doesn't interfere with the other tilt cord 42, 44, or the lift cord 32, 33.

If some of the cords 32, 33, 90, 41, 42, 43, 44 within the group, the group consisting of lift cords 32, 33, 90 and tilt cords 41, 42, 43, 44, enter the headrail 1 at a position along the length of the headrail 1 that is different from the point where other cords within the group enter the headrail 1 an unobstructed path for all of the cords 32, 33, 90, 41, 42, 43, 44 can be created.

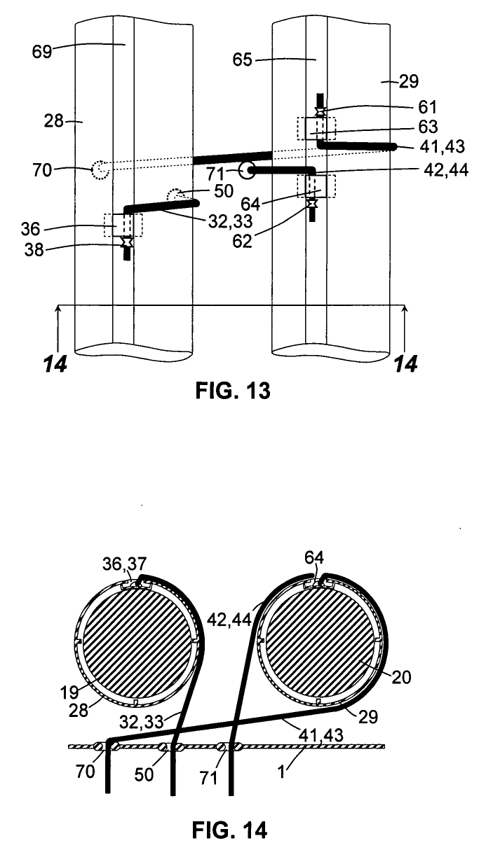

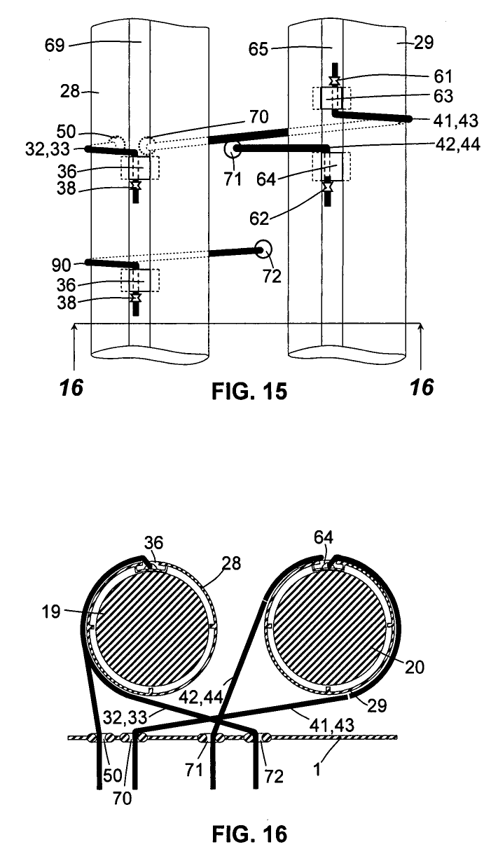

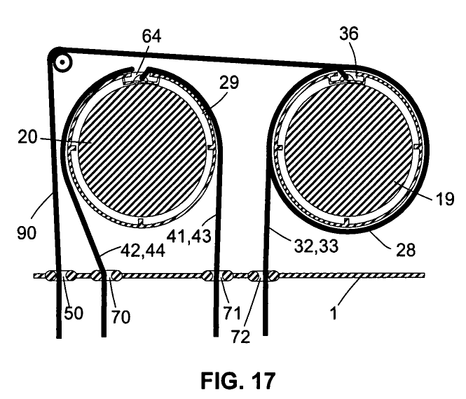

FIG. 13, 14, 15, and 16 show two different configurations that employ this method. FIG. 13 and 14 are two illustrations of the same configuration from two different perspectives that show routing implementations where the lift cord hole 50 is at a different position along the length of the headrail than the ladderbraid holes 70, 71. The configuration in FIG. 13 and 14 employs a single lift cord 32, 33 per lift point. FIG. 15 and 16 show a dual-lift-cord-per-lift-point configuration. FIG. 15 and 16 are two illustrations of the same configuration from two different perspectives. In FIG. 15 and 16 one of the lift cord holes 72 is at a different position along the length of the headrail than the other lift cord hole 50 and the tilt cord holes 70 71. FIG. 13, 14, 15, and 16 illustrate just two different configurations that employ this method. There are many possible configurations that can employ this method to create an unobstructed path for all of the cords 32, 33, 90, 41, 42, 43, 44.

Another method to achieve an unobstructed routing path for the cords 32, 33, 90, 41, 42, 43, 44 is to route each of the cords from one tube, around opposite sides of the opposite tube. For example, this could be accomplished by routing one tilt cord 41, 42, 43, 44 around one side of the lift tube, and routing the other tilt cord around the other side of the lift tube. Likewise this could be accomplished by routing one lift cord around one side of the tilt tube, and routing the other lift cord around the other side of the tilt tube. This method can be employed to create an unobstructed routing path for all of the cords.

There are many possible embodiments of this method. One embodiment of this method is shown in FIG. 17. In this embodiment the tilt cords 41, 42, 43, 44 are routed directly from the holes 70, 71 in the bottom of the headrail 1 to the tilt tube 29. In this embodiment one of the lift cords 32, 33 is routed directly to the lift tube 28. The other lift cord 90 is routed from the hole 50 in the bottom of the headrail 1, then around the tilt tube 29, and to the lift tube 28. The result is an unobstructed path for all of the cords 32, 33, 90, 41, 42, 43, 44.

A logic control unit 45 is used to coordinate the operation of the blind. Many embodiments of this logic control unit 45 are possible. The preferred embodiment uses a switch 52 as the input device. Many other types of input devices are possible which would include, but not be limited to: magnetic switches, proximity sensing switches, remote control, thermal switches, light sensors, solid states switches, relay switching. Although many types of switches could be used, the preferred embodiment uses a single single-pole, double-throw momentary contact switch 52 that is mounted vertically such that there is an “up” contact that is in the higher vertical position and a “down” contact that is in the lower vertical position. The logic control unit 45 can be configured many different ways to support a variety of different logical blind functions. However, for the preferred embodiment the functionality is divided into 5 basic operations as described below.

Operation 1: Pressing and holding the up contact causes slats 2 to tilt forward. Operation 1 is terminated when the up contact is released or when the angle of the slats 2 reach a completely vertical (closed) position

Operation 2: Pressing and holding the down contact causes slats 2 to tilt backward. Operation 2 is terminated when the down contact is released or when the angle of the slats 2 reaches a completely vertical (closed) position.

Operation 3: Pressing the up contact momentarily causes the slats 2 to first rotate into a horizontal angular position, then all the slats 2 are lifted to the top. Operation 3 is terminated when the up or down contact is momentarily pressed, or when the operation is complete. The operation completes when the slats 2 are at a horizontal (open) angle and the blind has reached the fully-raised position.

Operation 4: Pressing the down contact momentarily causes the slats 2 to first be dropped to their lowered-most position, then the slats 2 are rotated to a horizontal angular position. Operation 4 is terminated when the up or down contact is momentarily pressed, or when the operation is complete. The operation is complete when the when blind has reached the fully-lowered position and slats 2 reach a horizontal (open) angle.

Operation 5: Tapping the down contact twice in quick succession causes the slats 2 to be dropped to their fully lowered position. Operation 5 doesn't change the angle of the slats 2. Operation 5 is terminated when the up or down contact is momentarily pressed, or when the blind has reached the fully-lowered position.

A state diagram that shows the states of the preferred embodiment of the logic control unit is shown in FIG. 5.

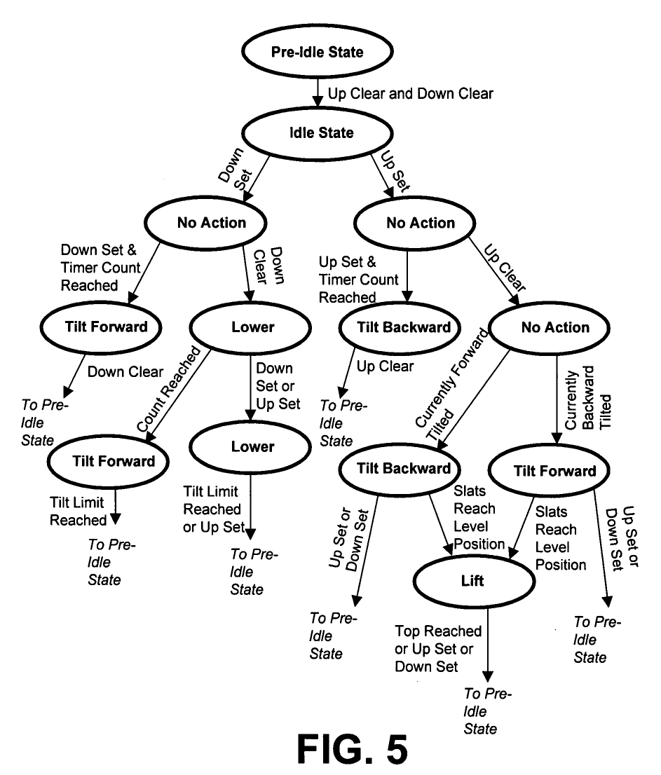

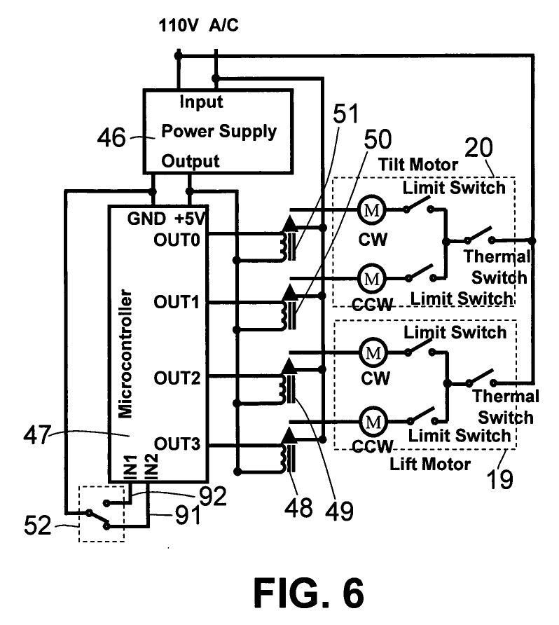

FIG. 6 shows a circuit diagram of the logic control unit 45 for the preferred embodiment. The logic control unit 45 is responsible for switching the motors 28, 29 on and off to drive the appropriate functions of the blind. The logic control unit 45 consists of a power supply 46, a microcontroller 47, and four relays 48, 49, 50, 5 1. The power supply 46 converts the AC input voltage to a DC voltage that can power the microcontroller 47 and relays 48, 49, 50, 5 1. A single-pole, double-pole momentary contact switch 52 is provided. The switch 52 provides inputs to a microcontroller 47, which performs the logic control functions. In this embodiment two of the I/O pins 91, 92 on the microcontroller 47 are defined as inputs. The two defined inputs 91, 92 have internal pull-up resistors that maintain a “high” on the input until they are pulled low by depressing the switch 52. Depressing the switch 52 in either direction causes the microcontroller 47 to read a “low” on the respective input. The microcontroller reads the signals from the switch 52 and determines the appropriate action to take using logic defined in the program. However, the program is first responsible for de-bouncing the switch; this is accomplished by waiting a short period of time (about 10 ms) after an input is read before any other inputs can be recognized.

The four outputs of the microcontroller 47 are connected to each of the four relays 48, 49, 50, 51: the first relay 49 enables driving the lift motor 19 clockwise, the second relay 48 enables driving the lift motor 19 counterclockwise, the third relay 51 enables driving the tilt motor 20 clockwise, the fourth relay 50 enables driving the tilt motor 20 counterclockwise. The embodiment of the present invention employs an Atmel AVR microcontroller 47. The Atmel AVR microcontrollers 47 have sufficient power to directly drive Tyco V23079A relays 48, 49, 50, 51. The Tyco V23079A relays 48, 49, 50, 51 are selected because they can be driven with just 28 mA, which is within the capabilities of the Atmel AVR 2313 microcontroller 47. These Tyco V23079A relays 48, 49, 50, 51 can switch a 5A load, more than enough for the motors 19, 20.

In the preferred embodiment, the logic control unit 45 is mounted within the headrail 1. It is mounted to one of the motor mounts 12. However, for safety, the logic control unit 45 is encased in a fire-resistant electrical box.

What is claimed is:

1. A control device for a motorized blind comprising:
a headrail, said headrail having a length suitable for extending between opposite sides of a window;
an input device;
a logic control unit, said logic control unit that receives signals from said input device, said logic control unit that processes input signals;
a plurality of slats with a length suitable for extending between opposite sides of a window;
a first motor, said first motor that is substantially controlled by said logic control unit, said first motor that substantially drives the position of said slats;
a second motor, said second motor that is substantially controlled by said logic control unit, said second motor that substantially drives the angle of said slats.

2. The control device of claim 1 wherein also comprising:
a first winding reel, said first winding reel that is mechanically connected to the output of said first motor;
a second winding reel, said second winding reel that is mechanically connected to the output of said second motor;
one or a plurality of lift cords, each of said lift cords with a first end and a second end, said first end of said lift cords that is connected to said first winding reel;
one or a plurality of tilt cords, each of said tilt cords with a first end and a second end, said first end of said tilt cords that is connected to said second winding reel.

3. A control device for a motorized blind comprising:
a headrail, said headrail having a length suitable for extending between opposite sides of a window;
an input device;
a logic control unit, said logic control unit that receives signals from said input device, said logic control unit that processes input signals;
a plurality of slats with a length suitable for extending between opposite sides of a window;
a plurality of motors that are substantially controlled by said logic control unit, said plurality of motors that substantially drive the angle and position of said slats.
